(19) United States
(12) Patent Application Publication
(10) Pub. No.: US 2025/0136522 A1
(43) Pub. Date: May 1, 2025

(54) COMPOSITION FOR GRANULAR UREA-BASED FERTILIZER

(71) Applicant: PRIVATE COMPANY LIMITED BY SHARES INNOVATION AGRO GROUP LIMITED, Sheung Wan, Hong Kong, Hong Kong (CN)

(72) Inventor: Vitaliy Aleksandrovich IZOSIN, Chelyabinskaya obl., Magnitogorsk (RU)

(21) Appl. No.: 18/682,986

(22) PCT Filed: May 31, 2022
(86) PCT No.: PCT/RU2022/000182

§ 371 Date: Feb. 12, 2024

(30) Foreign Application Priority Data
Aug. 11, 2021 (RU) 2021123872

(51) Int. Cl. C05C 9/00; C05C 3/00; C05G 3/90; C05G 5/12

(52) U.S. Cl. CPC C05C 9/00; C05C 3/00; C05G 3/90; C05G 5/12

(57) ABSTRACT

Inventions relate to agriculture. Compositions for granular fertilizer contain urea and functional additives, and as functional additives the compositions comprise ammonium sulfate and urease inhibitor alkylbenzyldimethylammonium chloride or didecyldimethylammonium chloride selected from the group of quaternary ammonium salts. All components are taken at a specific ratio. Inventions make it possible to prevent the decomposition of carbamide into ammonia and carbon dioxide, thus reducing nitrogen losses due to the introduction of a urease inhibitor into the composition of the granule, to provide a synergistic effect, to create a stable granular urea-ammonia mixture with no hygroscopicity.

### FIELD OF THE INVENTION

The invention relates to agrochemistry, specifically to the composition of the urea ammonium nitrate mixture (UAN) in granular form, which can be suitable for growing various types of field crops in any soil type.

### BACKGROUND OF THE INVENTION

Nitrogen is an essential plant nutrient. Nitrogen is needed to support the growth and development of plant life. Crop yields and the quality of agricultural products depend on nitrogen content in the soil. Agrochemistry has the available data on the exact amount of nitrogen extracted by plants from the soil during the growing season (for example, the average amount for wheat is 35 kg per 1 ton of grain). Agricultural producers apply the required amount of nitrogen to replenish utilized nitrogen and provide the necessary volume of nitrogen for the planned crop yield. The urea ammonium nitrate mixture is currently the most effective nitrogen nutrition.

Due to the high rate of urea decomposition in the soil, as a result of the action of soil bacteria urease, a critical task is to prolong the presence of nitrogen fertilizer in the ground and, accordingly, to inhibit the processes of its hydrolysis and decomposition.

There is a wide range of nitrogen fertilizers used in agriculture. Methods of producing these fertilizers are proposed and implemented in the industry: urea, calcium nitrate, ammonium nitrate with phosphate additive, etc. [“Ammonium Nitrate Technology”. Ed. V. M. Olevsky. Moscow, Chemistry, 1978; “Technology of Nitrogen Fertilizers”. V. A. Klevke, N. N. Polyakov, L. Z. Arsenyeva. Moscow, GHI, 1963].

The main types of nitrogen fertilizers are carbamide/urea—C (GOST 2081-2010), containing nitrogen in the amide form, ammonium nitrate—AN (GOST 2-2013), and calcium ammonium nitrate—CAN (TU 2181-001-77381580-2006), where nitrogen is present in ammonium and nitrate forms.

Nitrogen fertilizers UAN, UAN-28, UAN-30, and UAN-32 (liquid fertilizer) are widely used. Fertilizers of the UAN type have certain agrochemical advantages over other types of nitrogen fertilizers. The disadvantage of UAN fertilizers is that they are produced only in the form of aqueous solutions. The water, which is a part of the UAN solution, is ballast and causes additional costs for their transportation and storage.

Obtaining UAN in dry granular form is extremely difficult because of a very high hygroscopicity of urea and ammonium nitrate mixtures. The rational direction of solving the problem is to search for additives inhibiting negative processes.

Granular non-chlorine nitrogen-potassium-magnesium complex fertilizer is known (see Patent No. RU2672408 of 14 Nov. 2018), and it contains a mixture of urea with ammonium nitrate and potassium sulphate. However, this fertilizer contains potassium sulphate and ammonium nitrate. The fertilizer is suitable for growing various crops, mainly in acid soils.

There is a granular nitrogen fertilizer based on ammonium nitrate and urea with a sulphate additive, which granules contain an ammonium nitrate core, an outer urea shell, and an intermediate ammonium sulphate layer (see Patent No. RU2394799 of 20 Jul. 2010). However, with existing fertilizer, a fast decomposition of the top layer of carbamide into ammonia and carbon dioxide is possible because of hydrolysis induced by the action of soil bacteria urease, which leads to a loss of nitrogen up to 30-50%. In addition, the existing fertilizer has a high hygroscopicity.

Several urease inhibitors (substances slowing down the decomposition of carbamide by soil bacteria) are known to solve the problem of decomposition of urea into ammonia and carbon dioxide. These inhibitors allow hindering carbamide hydrolysis: N-(n-butyl) thiophosphoric triamide, N-(n-butyl) phosphoric triamide, thiophosphoryl triamide, phenylphosphordiamide, cyclohexylphosphoric triamide, cyclohexylthiophosphoric triamine phosphonamide triamine, phosphoric triamide, hydroquinone, p-benzoquinone, hexamidocyclotriphosphazene, thiopyridines, thiopyrimidines, thiopyridine-N-oxides, N, N-dihalo-2-imidazolidinone, N-halogen-2-oxazolidinone, their derivatives, or any combination thereof. Other examples of urease inhibitors include phenyl phosphorodiamidate (PPD/PPDA), hydroquinone, N-(2-nitrophenyl) phosphoric acid triamide (2-NPT). N-(n-butyl) thiophosphoric triamide (NBPT) is currently considered the most effective, although N-(n-propyl) thiophosphoric triamide, phenyl phosphorodiamidate (PPD), hydroquinone, ammonium thiosulfate, and thiocarbamide also possess inhibitory properties in relation to urease.

The disadvantage of the compositions using the above inhibitors is a low inhibitors' affinity for urea, and the low thermal stability of the inhibitors during urea granulation, which leads to partial decomposition of these inhibitors when introducing them into the urea melt. The usage of these inhibitors applied to urea granules is of low efficiency because the inhibitors are washed away by atmospheric precipitation. The main body of the granule, which is the usual, not inhibited carbamide, is decomposed by urease of soil bacteria at the ordinary decomposition rate.

The issue addressed by this invention is the necessity to develop a granular fertilizer composition based on a urea-ammonia mixture with sufficiently low hygroscopicity and a slow urea decomposition rate.

### SUMMARY OF THE INVENTION

The technical effects of the claimed invention are as follows:
prevention of urea decomposition into ammonia and carbon dioxide, thus reducing nitrogen losses due to the introduction of a urease inhibitor into the granule composition;
a synergistic effect when the action effect of one component is enhanced in the presence of another component;
creation of a stable granulated urea-ammonia mixture with no hygroscopicity.
   Ammonium sulfate used in the composition helps to achieve the indicated technical effects. Ammonium sulfate in the process of mixing with carbamide and the further granulating process does not make the mixture hygroscopic. And as a functional supplement, a urease inhibitor is used whose solubility is similar to the solubility of urea. A urease inhibitor is selected from group of quaternary ammonium salts, which prevents the decomposition of urea into ammonia and carbon dioxide, thus reducing the loss of nitrogen. The invented composition significantly reduces nitrogen losses compared with the situation when carbamide or carbamide together with Ammonium sulfate is used.

Particular embodiments of the invention are given below.

The composition for granulated fertilizer (Embodiment 1) containing urea and functional additives represented by Ammonium sulfate inhibitor and a urease Alkylbenzyldimethylammonium chloride selected from group of quaternary ammonium salts at a ratio of (wt. %):

| | |
|---|---|
| Urea (Carbamide) | 50-94%, |
| Ammonium sulfate | 5-45%, |
| Alkylbenzyldimethylammonium chloride | 0.3-5%. |

The composition for granulated fertilizer (Embodiment 2) containing urea and functional additives represented by Ammonium sulfate and a urease inhibitor Didecyldimethylammonium chloride, selected from group of quaternary ammonium salts, at a ratio of (wt. %):

| | |
|---|---|
| Urea (Carbamide) | 50-94%, |
| Ammonium sulfate | 5-45%, |
| Didecyldimethylammonium chloride | 0.3-5%. |

### The Implementation of the Invention

One of the basic principles of agrochemistry is the law of the limiting factor (Liebig's Law of the Minimum). It states that the yield achievable is dictated by the nutrient that is most limiting. Thus, the rate of growth of a plant, the size to which it grows, and its overall health depends on the amount of the scarcest of its essential nutrients that is available to it. (ECOLOGY AND SUSTAINABLE DEVELOPMENT, Sh. Sh. Khamzina, B. K. Zhumabekova, 2015, 2.3. Limiting Factors. Action Patterns of Abiotic and Biotic Factors. Liebig's Law of the Minimum). Its simple interpretation: the growth of the crop directly depends on the increase of the factor, which is at a minimum. In other words, if during the growing season there is a deficiency of any element, then for the further growth the plant will wait for the replenishment of this scarcest resource, without developing to the extent that it could develop if the balance is maintained. Due to this principle, a ratio was derived according to which a plant requires in average 1 kg of sulphur per 15 kg of nitrogen. With a lack of sulphur, the plant will not be able to consume nitrogen introduced into the soil and develop as good as possible. Based on this principle, a sulphur-containing component Ammonium sulfate is also introduced into the composition of the invention.

Ammonium sulfate in proposed amount is used to introduce the properties of a stable granular urea-ammonia mixture, which is characterized by the absence of hygroscopicity. An additional advantage of adding Ammonium sulfate to the composition is the ability to increase the content of sulphate sulphur in the composition up to 10%. Sulphate sulphur positively affects the nitrogen fixation by plants.

Quaternary ammonium salts in proposed amount is used to prevent the decomposition of urea into ammonia and carbon dioxide, thus reducing the loss of nitrogen.

Based on experience, the Applicant has determined that the best quality of the composition for granular fertilizer was achieved by using a urease inhibitor selected from group of quaternary ammonium salts. During the experiments carried out by the Applicant, it was determined that in order to achieve indicated technical effects, the most optimal is to use the following substances from group of quaternary ammonium salts:
Alkylbenzyldimethylammonium chloride with registration No. CAS 63449-41-2;
Didecyldimethylammonium chloride with international registration No. CAS 7173-51-5.

In the process of obtaining the claimed agent, the chemicals included in its composition react with each other, providing a composition for granular fertilizer, which allows achieving goals due to a synergistic effect, in which the action of one component is enhanced in the presence of another. Namely, due to the synergistic effect of the aggregate of components used, the composition for granular fertilizer, with the stated components' quantitative ratio, the tasks were solved, and the indicated technical effects were achieved, which was confirmed experimentally.

Study effects related to urea only are presented in Tables 3-8, column “Nitrogen losses when using urea without an inhibitor, %”.

I.e. when using urea only, there is no effect on inhibition of amide nitrogen decomposition process.

Studies have been undertaken in order to reduce urea hydrolysis using the composition of urea+Ammonium sulfate (Ammonium sulfate: 5%, 20%, 45%) without applying urease inhibitor.

TABLE 1

| | | Nitrogen losses when | Nitrogen losses when | Nitrogen losses when |
|---|---|---|---|---|
| | Nitrogen losses | using urea with | using urea with | using urea with |
| | when using urea | Ammonium sulfate | Ammonium sulfate | Ammonium sulfate |
| Number of | without Ammonium | (Ammonium sulfate | (Ammonium sulfate | (Ammonium sulfate |
| test days | sulfate, % | concentration 5%), % | concentration 20%), % | concentration 45%), % |
| 7 | 10.69 | 9.57 | 7.52 | 5.21 |
| 14 | 21.23 | 20.34 | 18.35 | 17.38 |
| 21 | 35.99 | 34.35 | 33.45 | 30.46 |
| 28 | 52.76 | 51.15 | 50.12 | 46.54 |

Urease is hydrolytic enzyme belonging to the group of amidases. It has a specific property to catalyse the hydrolysis of urea to carbon dioxide and ammonia:

CO(NH₂)₂+H₂O→CO₂+2NH₃

Le Chatelier's principle is applicable to any dynamic system and states: “When any system at equilibrium for a long period of time is subjected to a change in concentration, temperature, volume, or pressure, the system changes to a new equilibrium, and this change partly counteracts the applied change”.

“Thus, in accordance with Le Chatelier's principle, the chemical equilibrium shifts:

. . .
in the direction of the counter reaction with decreasing the concentration of the source substances and increasing the concentration of the reaction products;”

PHYSICAL CHEMISTRY: CHEMICAL EQUILIBRIUM, L. V. Senicheva, V. A. Yargaeva, State Educational Institution of Higher Vocational Education “Pacific National University” (PNU), approved by the PNU Publishing-Library Council as a learning aid, Khabarovsk, PNU Publishing House, 2008.

Therefore, in accordance with Le Chatelier's principle, when adding ammonium ions to the catalytic reaction of hydrolysis of urea by urease, the equilibrium shifts towards the reverse reaction, i.e. inhibition of urease action.

Tests were carried out for Urea+Ammonium sulfate. Test results showed inhibition of carbamide hydrolysis, however, insufficient for practical application. Therefore, in order to enhance the action of Ammonium sulfate, additional substances containing ammonium (quaternary ammonium salts) were found, which greatly enhanced the effect of the composition in relation to the inhibition of carbamide hydrolysis processes.

Therein, the experimentally selected quantitative ratio of all components of the composition has a significant impact on the effectiveness of the proposed composition for granular fertilizer. The composition parameters are optimal. They are obtained by calculation and worked out according to the results of experiments.

The main consideration in creating the composition according to the invention is to develop a composition with an optimal amount of nitrogen. Sulphur to nitrogen content ratio in the range of 1:3.5-26.

Sulphur content in Ammonium sulfate (NH₄)₂SO₄:

$${( {NH}_{4} )}_{2} = 18 , 038 * 2 = 36 , 076$$

$${SO}_{4} = 32 + 16 * 4 = 96$$

$$S = 32 / ( 36 , 075 + 96 ) * 100 \% \approx 24 , 23 \%$$

With sulphur to nitrogen ratio 1:3,5-26 the optimal nitrogen content in the obtained composition is 35-40%. Thus, it is necessary to obtain 1.5-11% sulphur in the composition: 1,5-11/0,2423≈5-45% at Ammonium sulfate.

Quaternary ammonium salts concentrations are based on the studies. The results are presented in Tables 3-8.

The technology of preparation of the claimed composition for granulated fertilizer can be implemented on the known equipment used in industrial conditions, for example, on the existing technological line for granulated urea production by introducing moistened Ammonium sulfate and quaternary ammonium salts melt into the flow of urea melt before prilling tower. It is known that substances with hydro solubility close to carbamide are well mixed with carbamide. They are compounds based on ammonium and quaternary ammonium salts.

Equipment used in the production of granulated urea is described in technical literature, see, for example, D. M. Gorlovsky et al., “Urea Technology”, L.: Khimiya, 1981, page 320.

This source of information describes the stage of liquids evaporation to high concentrations (see page 186). The proposed inhibitor for urea hydrolysis and the solution of Ammonium sulfate should be introduced before this technological stage using conventional dosing pumps providing proportional dosing the inhibitor solution and Ammonium sulfate solution into the urea flow based on average urea concentration in the evaporated solution. Obtained homogeneous melt is a result of water evaporation from the solutions. This melt runs to the prilling tower. Urea granulation is described in this source of information starting with page 190.

Patent RU2595696C2, Aug. 27, 2016—27.08.2016 describes a method of preparing granulated urea by granulating a urea solution in a fluidised bed, taking place along a mainly longitudinal growth path, from the granulation starting point (1S) to the end point of fluidised bed product discharge (1 E). Urea solution enters the fluidised bed by means of several urea inputs (2 A, 2 B, 2 C) taken from the main urea flow (2), where an additive (6) is mixed with urea solution. Additive concentration in urea input flows is not uniform, so at least two of said urea inputs have a different concentration of additive. Additive is divided into several additive streams (6 A-6 C), and each additive stream is mixed directly with a corresponding urea input (2 A-2 C).

### EXAMPLES

The essence of the claimed invention is illustrated by an example of the preparation of the claimed composition for granular fertilizer.

The claimed composition for granular fertilizer was prepared as described above, but in laboratory conditions (Table 2 shows specific examples illustrating the invention).

The claimed composition (Embodiment 1) is prepared from the estimated amount of urea, Ammonium sulfate, and Alkylbenzyldimethylammonium chloride. The primary components are weighed. Urea is placed into a glass-lined reactor with a capacity of 25 l, equipped with a mixer. Simultaneous heating and maintaining the temperature up to 140° C. is provided. Then Ammonium sulfate and Alkylbenzyldimethylammonium chloride are added consistently providing constant mixing until complete melting. Then, granules are obtained from the resulting homogeneous melt by cooling each drop of the received melt.

The claimed composition (Embodiment 2) is prepared from the estimated amount of urea, Ammonium sulfate, and Didecyldimethylammonium chloride. The primary components are weighed. Urea is placed into a glass-lined reactor with a capacity of 25 l, equipped with a mixer. Simultaneous heating and maintaining the temperature up to 140° C. is provided. Then Ammonium sulfate and Didecyldimethylammonium chloride are added consistently providing constant mixing until complete melting. Then, granules are obtained from the resulting homogeneous melt by cooling each drop of the received melt.

TABLE 2

| | | | |
|---|---|---|---|
| Composition (wt. %) | Composition 1 | Composition 2 | Composition 3 |

Embodiment 1

| | | | |
|---|---|---|---|
| Urea | 94.0 | 77.5 | 50.0 |
| Ammonium sulfate | 5.0 | 20.0 | 45.0 |
| Alkylbenzyldimethylammonium | 0.3 | 2.5 | 5.0 |
| chloride | | | |

Embodiment 2

| | | | |
|---|---|---|---|
| Urea | 94.0 | 77.5 | 50.0 |
| Ammonium sulfate | 5.0 | 20.0 | 45.0 |
| Didecyldimethylammonium | 0.3 | 2.5 | 5.0 |
| chloride | | | |

Appearance and hygroscopicity check is provided by visual inspection and in accordance with the method for determination of looseness, see GOST 21560.5-82.

Obtained compositions are characterized by the following properties: they are not hygroscopic, do not clod up. Obtained compositions possess sufficient looseness according to GOST 21560.5-82. Pellet hardness exceeds hardness of urea pellets.

Determination of the effectiveness of the composition concerning nitrogen losses reduction was carried out based on measuring and comparing the amount of ammonia released during urea decomposition and during decomposition of the above compositions.

When determining the effectiveness of inhibition, the soil moistened with distilled water was used (15 ml of distilled water per each 100 g of soil). The soil with pH 7.6 of soil-water extract was preliminarily selected for testing (to determine pH of soil-water extract, 30 g of soil was suspended in 150 ml of distilled water for 30 min, after which the pH of the obtained suspension was measured). Wet soil was placed in a 230 ml open plastic cuvette. 2 g of urea granules (control sample) and 2 g of granules of the above compositions were applied to the surface of moistened soil.

The cuvette with the moistened soil with urea granules of control sample and granules of the above compositions applied to its surface was placed in an external sealed container with previously added 100 ml of distilled water, after which the outer sealed container was closed.

The container was maintained at room temperature (20° C.) in a thermostatically controlled air box for seven, fourteen, twenty-one and twenty-eight days.

After that the water containing absorbed ammonia from a sealed container was analysed for ammonia content according to PND F (Federative Environmental Normative Document) 14.1.2:3.1-95 “Quantitative Chemical Analysis of Water. Technique for Measuring the Mass

Concentration of Ammonium Ions in Natural and Waste Waters by the Photometric Method with Nessler's Reagent”

The test results are presented in Tables 3-8. Since the main objective of the invention is to preserve the maximum amount of nitrogen in the soil during plants growing season (due to inhibition of urea hydrolysis in the soil), the practical benefit of this invention is in crop yield enhancement in field conditions.

The scientific literature presents the exact values for chemical elements removal from the soil per amount of agricultural products received, see, for example, the Study Guide to practical studies on the discipline “Fertilizer System in Crop Rotations”, KAZAN FEDERAL UNIVERSITY, INSTITUTE OF ECOLOGY AND NATURE MANAGEMENT, Department of Soil Science, L. YU. RYZHIKH, A. I. LIPATNIKOV, Kazan—2018.

Based on the studies presented in the claim, the proposed composition preserves up to 91.31% of applied nitrogen in the soil in the early stages of vegetation, while usage of urea only saves just 47.24% of the applied nitrogen. Thus, under otherwise equal conditions of soil treatment and plant cultivation, and based on the tables of removal of elements from the soil per unit of production, the actual crop yield in practice increases definitely.

The most important factor determining the choice of additional components was the components' availability, relatively low cost, the efficiency of their usage and environmental safety. In addition to expanding the range of fertilizers, the proposed composition for granular fertilizer, according to the Applicant, will be in great demand right now since it will significantly increase the efficiency of application of nitrogen fertilizers based on urea, which will lead to an increase in crop yield and quality of agricultural products, and will improve efficiency of agricultural production. The claimed composition for granular fertilizer, according to the applicant, allows meeting the long need for such a product.

TABLE 3
Effectiveness measurement results. Composition 1 (Embodiment 1)

| | | | | Ammonia | Ammonia | | Nitrogen | | | |
|---|---|---|---|---|---|---|---|---|---|---|
| | Ammonia | Ammonia | | losses, | losses, | | losses, | Nitrogen | Nitrogen | |
| | content | content | Ammonia | mg from | mg, from | Nitrogen | mg, from | losses, | losses when | Nitrogen |
| | in the | in the | content, | 2 g of | 2 g of | content, | 2 g of | mg, from | using urea | losses when |
| Number | control | test | mg, in | urea, | urea, | mg, in 2 | urea, | 2 g of | without | using the |
| of test | sample, | sample, | 2 g of | control | test | g of | control | the test | inhibitor, | test sample, |
| days | mg/l | mg/l | urea | sample | sample | urea | sample | sample | % | % |
| 7 | 1194 | 185.12 | 1120.00 | 119.40 | 18.51 | 920.00 | 98.33 | 15.25 | 10.69 | 1.66 |
| 14 | 2371.5 | 815.00 | 1120.00 | 237.15 | 81.50 | 920.00 | 195.30 | 67.12 | 21.23 | 7.30 |
| 21 | 4021 | 1135.00 | 1120.00 | 402.10 | 113.50 | 920.00 | 331.14 | 93.47 | 35.99 | 10.16 |
| 28 | 5893.70 | 1586.12 | 1120.00 | 589.37 | 158.61 | 920.00 | 485.36 | 130.62 | 52.76 | 14.20 |

TABLE 4
Effectiveness measurement results. Composition 2 (Embodiment 1)

| | | | | Ammonia | Ammonia | | Nitrogen | | | |
|---|---|---|---|---|---|---|---|---|---|---|
| | Ammonia | Ammonia | | losses, | losses, | | losses, | Nitrogen | | |
| | content | content | Ammonia | mg from | mg, from | Nitrogen | mg, from | losses, | Nitrogen | Nitrogen |
| | in the | in the | content, | 2 g of | 2 g of | content, | 2 g of | mg, from | losses when | losses when |
| Number | control | test | mg, in | urea, | urea, | mg, in | urea, | 2 g of | using urea | using the |
| of test | sample, | sample, | 2 g of | control | test | 2 g of | control | the test | without | test sample, |
| days | mg/l | mg/l | urea | sample | sample | urea | sample | sample | inhibitor, % | % |
| 7 | 1194.00 | 154.50 | 1120.00 | 119.40 | 15.45 | 920.00 | 98.33 | 12.72 | 10.69 | 1.38 |
| 14 | 2371.50 | 785.34 | 1120.00 | 237.15 | 78.53 | 920.00 | 195.30 | 64.68 | 21.23 | 7.03 |
| 21 | 4021.00 | 796.10 | 1120.00 | 402.10 | 79.61 | 920.00 | 331.14 | 65.56 | 35.99 | 8.46 |
| 28 | 5893.70 | 1381.00 | 1120.00 | 589.37 | 138.10 | 920.00 | 485.36 | 113.73 | 52.76 | 12.36 |

TABLE 5
Effectiveness measurement results. Composition 3 (Embodiment 1)

| | | | | Ammonia | Ammonia | | Nitrogen | | | |
|---|---|---|---|---|---|---|---|---|---|---|
| | Ammonia | Ammonia | | losses, | losses, | | losses, | Nitrogen | Nitrogen | |
| | content | content | Ammonia | mg from | mg, from | Nitrogen | mg, from | losses, | losses when | Nitrogen |
| | in the | in the | content, | 2 g of | 2 g of | content, | 2 g of | mg, from | using urea | losses when |
| Number | control | test | mg, in | urea, | urea, | mg, in | urea, | 2 g of | without | using the |
| of test | sample, | sample, | 2 g of | control | test | 2 g of | control | the test | inhibitor, | test sample, |
| days | mg/l | mg/l | urea | sample | sample | urea | sample | sample | % | % |
| 7 | 1194.00 | 85.23 | 1120.00 | 119.40 | 8.52 | 920.00 | 98.33 | 7.02 | 10.69 | 0.76 |
| 14 | 2371.50 | 512.50 | 1120.00 | 237.15 | 51.25 | 920.00 | 195.30 | 42.21 | 21.23 | 4.59 |
| 21 | 4021.00 | 762.20 | 1120.00 | 402.10 | 76.22 | 920.00 | 331.14 | 62.77 | 35.99 | 6.82 |
| 28 | 5893.70 | 1047.56 | 1120.00 | 589.37 | 104.76 | 920.00 | 485.36 | 86.27 | 52.76 | 9.38 |

TABLE 6
Effectiveness measurement results. Composition 1 (Embodiment 2)

| | Ammonia | | | | | | | | Nitrogen | |
|---|---|---|---|---|---|---|---|---|---|---|
| | content | Ammonia | | Ammonia | Ammonia | | Nitrogen | Nitrogen | losses when | Nitrogen |
| | in the | content in | Ammonia | losses, mg | losses, mg, | Nitrogen | losses, mg, | losses, mg, | using urea | losses when |
| Number | control | the test | content, mg, | from 2 g of | from 2 g | content, | from 2 g of | from 2 g of | without | using the |
| of test | sample, | sample, | in 2 g | urea, control | of urea, | mg, in 2 g | urea, control | the test | inhibit | test sample, |
| days | mg/l | mg/l | of urea | sample | testsample | of urea | sample | sample | or, % | % |
| 7 | 1194.00 | 161.80 | 1120.00 | 119.40 | 16.18 | 920.00 | 98.33 | 13.32 | 10.69 | 1.45 |
| 14 | 2371.50 | 791.00 | 1120.00 | 237.15 | 79.10 | 920.00 | 195.30 | 65.14 | 21.23 | 7.08 |
| 21 | 4021.00 | 945.00 | 1120.00 | 402.10 | 94.50 | 920.00 | 331.14 | 77.82 | 35.99 | 8.46 |
| 28 | 5893.70 | 1315.84 | 1120.00 | 589.37 | 131.58 | 920.00 | 485.36 | 108.36 | 52.76 | 11.78 |

TABLE 7
Effectiveness measurement results. Composition 2 (Embodiment 2)

| | | | | Ammonia | Ammonia | | Nitrogen | | | |
|---|---|---|---|---|---|---|---|---|---|---|
| | Ammonia | Ammonia | | losses, | losses, | | losses, | Nitrogen | Nitrogen | |
| | content | content | Ammonia | mg from | mg, from | Nitrogen | mg, from | losses, | losses when | Nitrogen |
| | in the | in the | content, | 2 g of | 2 g of | content. | 2 g of | mg, from | using urea | losses when |
| Number | control | test | mg, in | urea, | urea, | mg, in | urea, | 2 g of | without | using the |
| of test | sample, | sample, | 2 g of | control | test | 2 g of | control | the test | inhibit or, | test sample, |
| days | mg/l | mg/l | urea | sample | sample | urea | sample | sample | % | % |
| 7 | 1194.00 | 128.70 | 1120.00 | 119.40 | 12.87 | 920.00 | 98.33 | 10.60 | 10.69 | 1.15 |
| 14 | 2371.50 | 689.81 | 1120.00 | 237.15 | 68.98 | 920.00 | 195.30 | 56.81 | 21.23 | 6.17 |
| 21 | 4021.00 | 812.00 | 1120.00 | 402.10 | 81.20 | 920.00 | 331.14 | 66.87 | 35.99 | 7.27 |
| 28 | 5893.70 | 1012.00 | 1120.00 | 589.37 | 101.20 | 920.00 | 485.36 | 83.34 | 52.76 | 9.06 |

TABLE 8
Effectiveness measurement results. Composition 3 (Embodiment 2)

| | | | | Ammonia | Ammonia | | Nitrogen | | | |
|---|---|---|---|---|---|---|---|---|---|---|
| | Ammonia | Ammonia | | losses, | losses, | | losses, | Nitrogen | Nitrogen | |
| | content | content | Ammonia | mg from | mg, from | Nitrogen | mg, from | losses, | losses when | Nitrogen |
| | in the | in the | content, | 2 g of | 2 g of | content, | 2 g of | mg, from | using urea | losses when |
| Number | control | test | mg, in | urea, | urea, | mg, in | urea, | 2 g of | without | using the |
| of test | sample, | sample, | 2 g of | control | test | 2 g of | control | the test | inhibitor, | test sample, |
| days | mg/l | mg/l | urea | sample | sample | urea | sample | sample | % | % |
| 7 | 1194.00 | 60.56 | 1120.00 | 119.40 | 6.06 | 920.00 | 98.33 | 4.99 | 10.69 | 0.54 |
| 14 | 2371.50 | 696.20 | 1120.00 | 237.15 | 69.62 | 920.00 | 195.30 | 57.33 | 21.23 | 6.23 |
| 21 | 4021.00 | 784.37 | 1120.00 | 402.10 | 78.44 | 920.00 | 331.14 | 64.60 | 35.99 | 7.02 |
| 28 | 5893.70 | 970.70 | 1120.00 | 589.37 | 97.07 | 920.00 | 485.36 | 79.94 | 52.76 | 8.69 |

1. The composition for granulated fertilizer containing urea and functional additives, wherein as the functional additives the composition comprises Ammonium sulfate and a urease inhibitor Alkylbenzyldimethylammonium chloride selected from quaternary ammonium salts at a ratio of (wt. %):

| | |
|---|---|
| Urea (Carbamide) | 50-94%, |
| Ammonium sulfate | 5-45%, |
| Alkylbenzyldimethylammonium chloride | 0.3-5%. |

2. The composition for granulated fertilizer containing urea and functional additives, wherein as the functional additives the composition comprises Ammonium sulfate and a urease inhibitor Didecyldimethylammonium chloride, selected from group of quaternary ammonium salts, at a ratio of (wt. %):

| | |
|---|---|
| Urea (Carbamide) | 50-94%, |
| Ammonium sulfate | 5-45%, |
| Didecyldimethylammonium chloride | 0.3-5%. |
